(19) United States
(12) Patent Application Publication
(10) Pub. No.: US 2014/0379533 A1
(43) Pub. Date: Dec. 25, 2014

(54) STORY BASED SELLING OF PRODUCTS

(71) Applicant: One Kings Lane, Inc., San Francisco, CA (US)

(72) Inventors: Josh Liberson, San Francisco, CA (US); Jean Sini, San Francisco, CA (US); Sarah Oppelt, San Francisco, CA (US); Ethan Trask, San Francisco, CA (US)

(73) Assignee: One Kings Lane, Inc., San Francisco, CA (US)

(21) Appl. No.: 13/924,285

(22) Filed: Jun. 21, 2013

(51) Int. Cl. G06Q 30/06

(52) U.S. Cl. CPC G06Q 30/0643; G06Q 30/0623
USPC 705/27.2

(57) ABSTRACT

Disclosed are methods, systems, paradigms and structures for story based selling of products. An online sales event of a number of products is presented to consumers as a story. The products are presented as characters of the story. Related products are categorized into specific chapters of the story. The story can be based on a theme, a category, an occasion, an event, etc. For example, the story can be “Father's Day,” and all products that can be gifted to a father can be presented as various characters categorized under various chapters such as “Golf,” “Fishing,” “Board games” etc. Some embodiments present the story in a graphical user interface (GUI). The GUI includes an introduction of the story, a table of contents, chapters, etc. for a story. The GUI presents certain characters with special features such as a different size, color, narratives, or on-character messages to distinguish them over other characters.

### TECHNICAL FIELD

This disclosure relates to electronic commerce and more specifically to generating a graphical user interface for story based selling of products.

### BACKGROUND

An online selling entity offers various products and services for sale via, for example, a website associated with the online selling entity. A consumer interested in learning about or purchasing a particular service or product visits the website and searches for the particular product or service. Current graphical user interface (GUI) of the online selling entities are generally less intuitive, less pleasing, less attractive, less interesting for the consumers to navigate. The current GUIs provide a complex interface which is confusing to the consumer. Because of the complex GUI, the consumer may end up not finding the particular product or service even though the product or service is available. The GUIs of the current websites fail to provide a pleasant shopping experience to the consumer and therefore, fail to create an interest in the consumer to visit the websites. This, typically results in a lost opportunity for a potential sale, which can affect both the online selling entity and a vendor who is selling the product through the online selling entity.

### SUMMARY

Disclosed are methods, systems, paradigms and structures for story based selling of products. An online sales event offering a number of products for sale is presented to consumers as a story. In one possible embodiment, related products are categorized into specific chapters of the story and the products are presented as characters of the story. The story can be based on a theme, a category, an occasion, an event, etc. For example, the story can be “Father's Day,” and all products that can be gifted to a father can be presented as various characters categorized under various chapters such as “Golf,” “Fishing,” “Board games,” etc.

In some embodiments, a graphical user interface (GUI) is generated to present the online sales event as a story. The GUI presents the story in a specific format. The GUI includes separate portions for presenting a story introduction, a table of contents identifying the chapters of the story, chapters having the characters, etc. Each of the story introduction, table of contents, chapters, characters presented within the chapters and any other details pertaining to the story can include multi-media content such as a text, an image, a video, or an audio representing the specific details. Further, the GUI presents certain characters (referred to as “special characters”) with special features, for example, a different size, color, additional narratives, an on-character message, etc. to distinguish them over other characters.

The GUI simplifies the navigation and enhances the shopping experience for a user by presenting the sales event as a story. The user may navigate through the products on sale in the sales event by navigating the story presented in the GUI.

Some embodiments of the disclosed technique have other aspects, elements, features, and steps in addition to or in place of what is described above. These potential additions and replacements are described throughout the rest of the specification.

### BRIEF DESCRIPTION OF THE DRAWINGS

FIG. 1 is an environment in which an embodiment of the disclosed technique may operate.

FIG. 2 is a flow diagram illustrating a process of story based selling of products.

FIG. 3 is a flow diagram illustrating a process of conceptualizing an online sales event as a story.

FIG. 4 is a flow diagram illustrating a process of generating a graphical user interface (GUI) for the story of FIG. 3.

FIG. 5, which includes FIGS. 5A, 5B and 5C, illustrates an example GUI created using the process of FIG. 4.

FIG. 6 is a block diagram of a system for generating the GUI for presenting the sales event as a story.

FIG. 7 is a block diagram of a processing system that can implement operations of the present disclosure.

### DETAILED DESCRIPTION

References in this description to “an embodiment”, “one embodiment”, or the like, mean that the particular feature, function, or characteristic being described is included in at least one embodiment of the present disclosure. Occurrences of such phrases in this specification do not necessarily all refer to the same embodiment, nor are they necessarily mutually exclusive.

Disclosed are methods, systems, paradigms and structures for story based selling of products. An online sales event offering a number of products for sale is presented to consumers as a story. In one possible embodiment, related products are categorized into specific chapters of the story and the products are presented as characters of the story. The story can be based on a theme, a category, an occasion, an event, etc. For example, the story can be “Father's Day,” and all products that can be gifted to a father can be presented as various characters categorized under various chapters such as “Golf,” “Fishing,” “Board games,” etc.

In some embodiments, a graphical user interface (GUI) is generated to present the online sales event as a story. The GUI presents the story in a specific format. The GUI includes separate portions for presenting a story introduction, a table of contents identifying the chapters of the story, chapters having the characters, etc. Each of the story introduction, table of contents, chapters, characters presented within the chapters and any other details pertaining to the story can include multi-media content such as a text, an image, a video, or an audio representing the specific details. Further, the GUI presents certain characters (referred to as “special characters”) with special features, for example, a different size, color, additional narratives, an on-character message, etc. to distinguish them over other characters.

The GUI simplifies the navigation and enhances the shopping experience for a user by presenting the sales event as a story. The user may navigate through the products on sale in the sales event by navigating the story presented in the GUI.

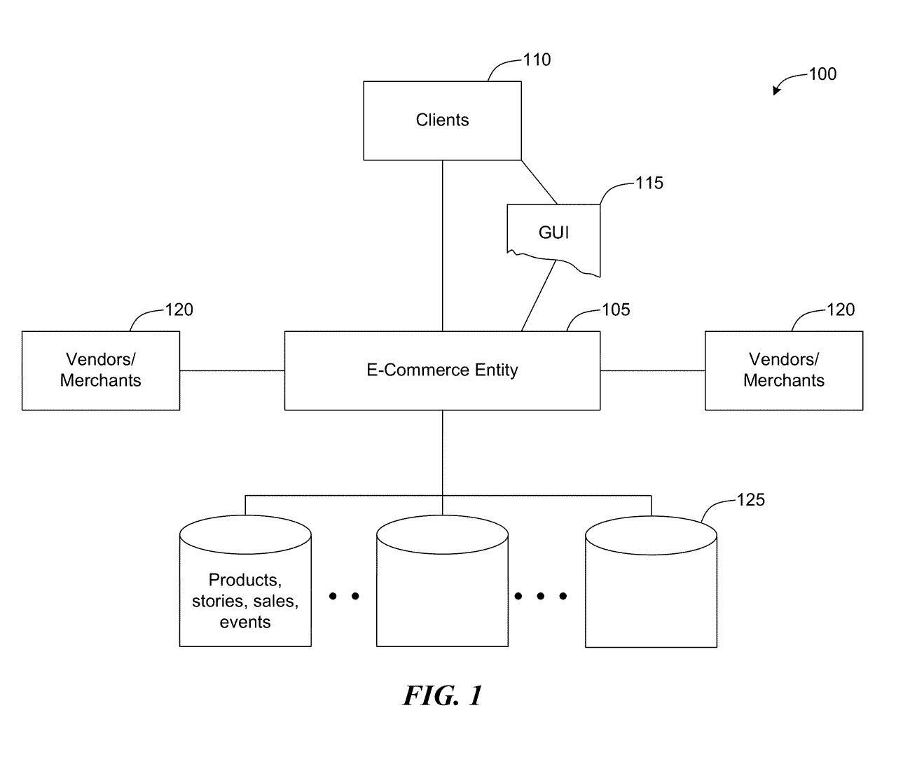

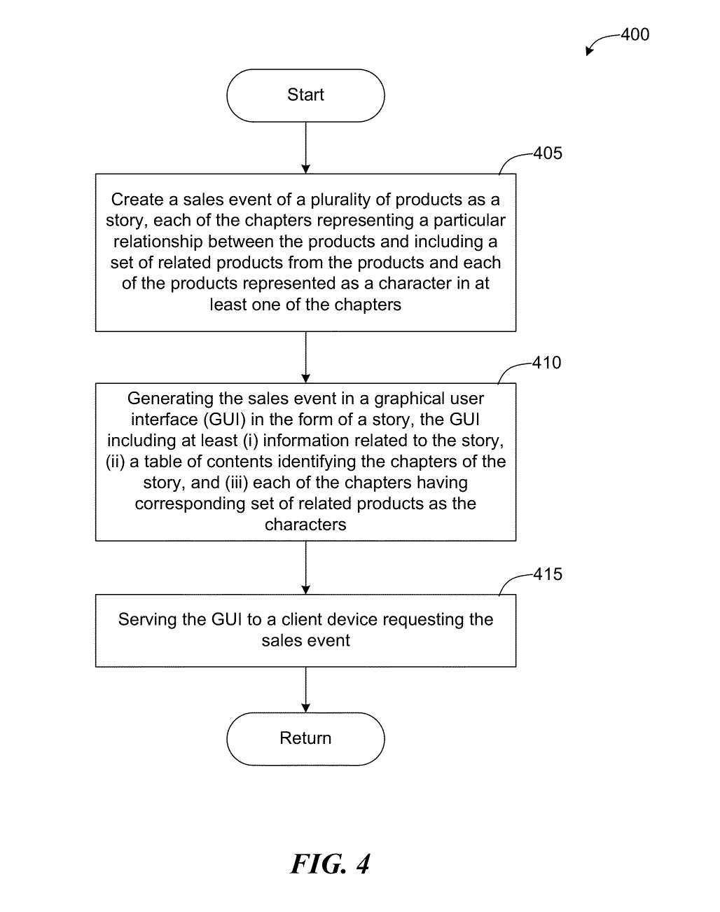

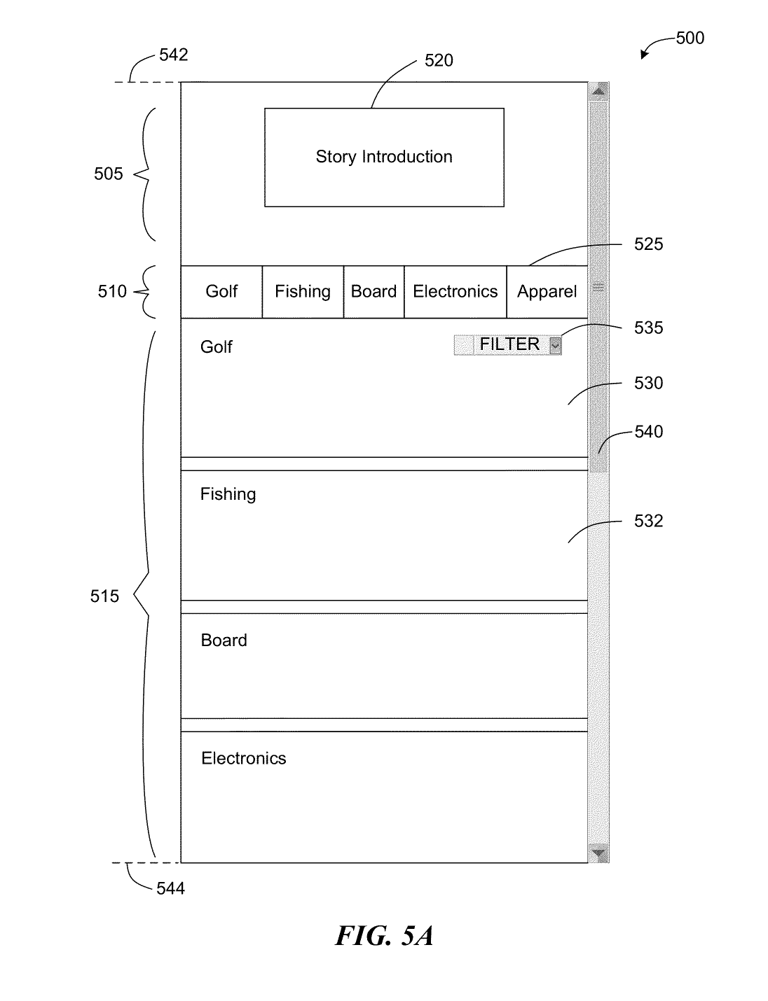

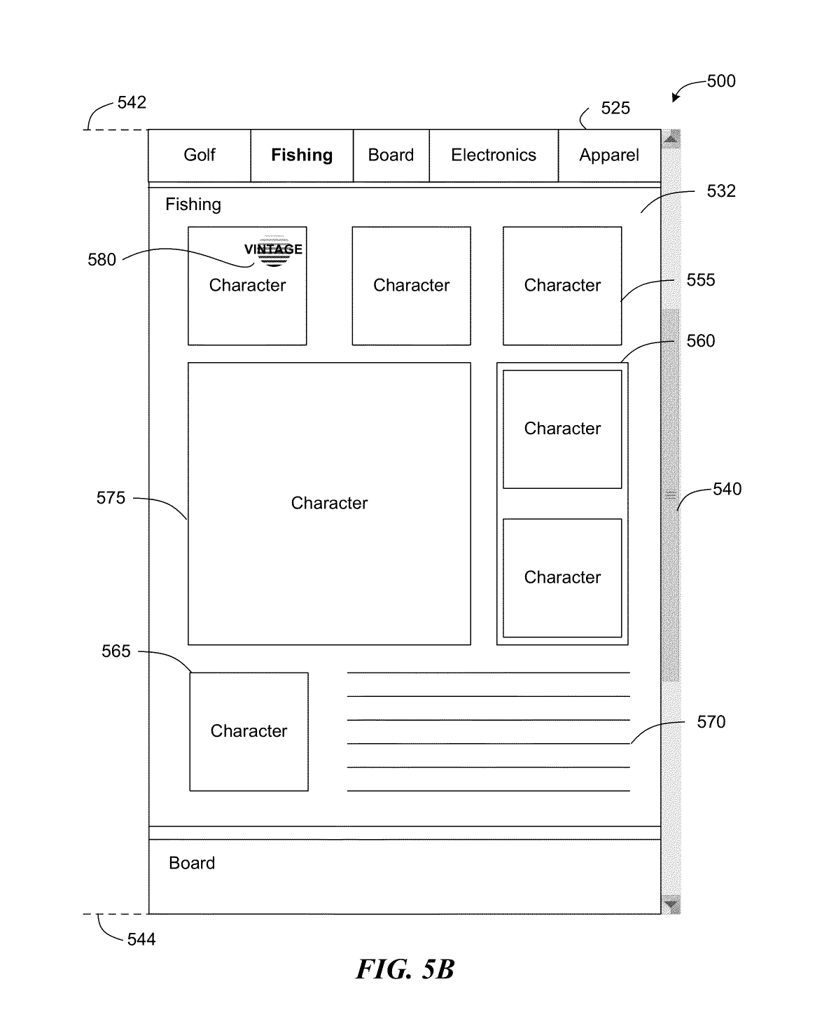

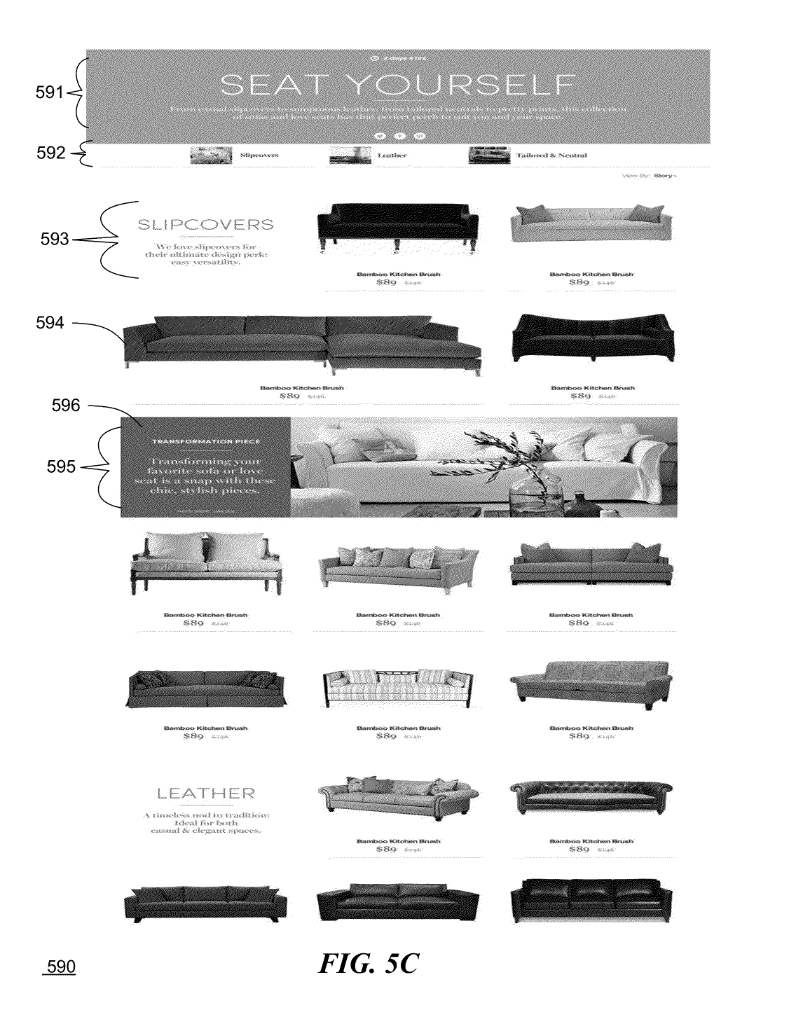

FIG. 1 is an environment in which an embodiment of the disclosed technique may operate. The environment 100 for story based selling of products can include an online environment such as e-commerce, web commerce or Internet commerce. An online selling entity such as e-commerce entity 105 offers products for sale to consumers via online means such as Internet. In at least some embodiments, the e-commerce entity 105 offers the products for sale using the story based selling concept. The e-commerce entity 105 hosts various applications that may be necessary for operating the e-commerce environment. One such application of the e-commerce entity 105 generates a story for selling a set of products. Another application generates the GUI 115 for presenting the sale of products in a story format. Additional details regarding the GUI are discussed with reference to, for example, FIGS. 4 and 5.

The e-commerce entity 105 offers various products (and/or services), including products made by or for the e-commerce entity 105 and also products from various other vendors or merchants 120. The products offered for sale can include a wide variety, for example, furniture, home improvement goods, apparel, pictures, frames, sculptures, recreational goods, services, etc. The e-commerce entity 105 provides an online selling platform (for example, via an application programming interface (API)) for vendors or merchants 120 who wish to sell their products via the e-commerce entity 105. In at least some embodiments, the vendors may access various applications executing or hosted on the e-commerce entity 105 using the API. The vendors or merchants 120 may also use the API of the e-commerce entity 105 to provide details such as the products, prices for the products, pricing strategies, duration of the sale for the products, any other policies with respect to selling the product that might have to be agreed upon the involved parties. Further, the e-commerce entity 105 may also have policies, for example, pricing, profit sharing, type of products, etc. which the vendors or merchants 120 may have to comply with for selling their products using the e-commerce entity 105.

Storage system 125 can include storage units such as a database. In at least some embodiments, the storage system 125 stores various details regarding inventory of products offered for sale, pricing strategies, sale strategies, stories, themes for stories, concepts for stories, multi-media content for presenting the products and stories, GUI generating applications, user accounts, user profiles, transactions, etc. In an embodiment, any user who wants to view or buy products from the e-commerce entity 105 may be asked to create a user account. Further, the user may also be asked to provide other personal details such as age, income, gender, their preferences to types of products, merchants, colors of products, etc. which are stored in as a user profile. The user profile may be used to personalize/customize the set of products presented to a particular user. The e-commerce entity 105 accesses the storage system 125 to obtain necessary data for the operation of the environment 100.

Clients 110 may view and/or purchase the products offered for sale by the e-commerce entity 105 by accessing the GUI 115. Clients 110 may access the GUI 115 via various channels, including through a website associated with the e-commerce entity 105 or an application “app” of the e-commerce entity 105 that allows the users to view and/or purchase the products from the e-commerce entity 105. Clients 110 can include a plurality of devices such as a computer, a laptop, a mobile phone, a tablet PC, etc. The GUI 115 presenting the products using a story based selling concept, which organizes a set of products in the form of a story, provides an enhanced shopping experience to clients 110 viewing the products offered by the e-commerce entity 105.

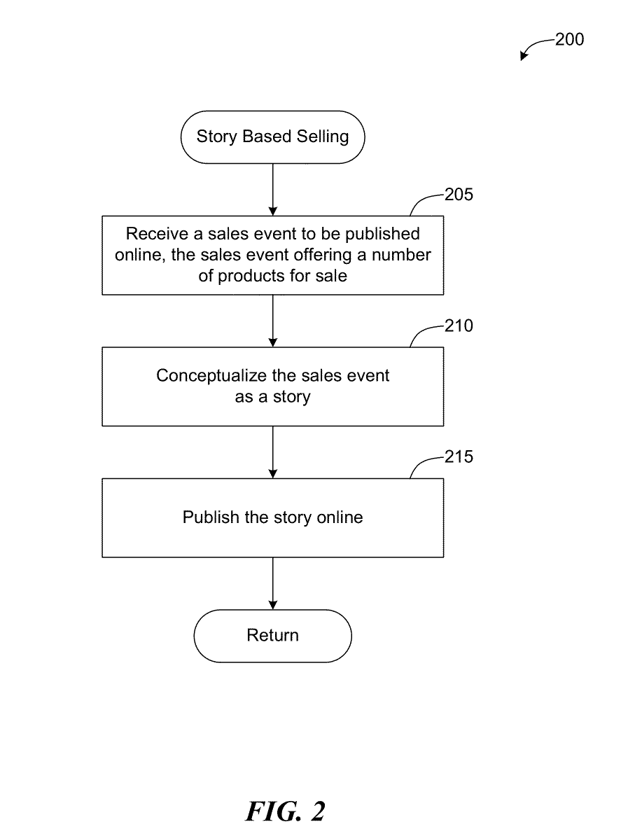

FIG. 2 is a flow diagram illustrating a process of story based selling of products, according to an embodiment of the disclosed technique. The method 200 may be executed in an environment such as environment 100 of FIG. 1. At step 205, the e-commerce entity 105 receives a sales event to be published online to the consumers. The sales event offers a number of products for sale. The products offered for sale in a particular sale event could be of a specific vendor, a number of vendors, a particular category, theme, occasion, etc. Further, the sales event may be offered for a predefined period of time such as an hour, a day, three days, a week, etc.

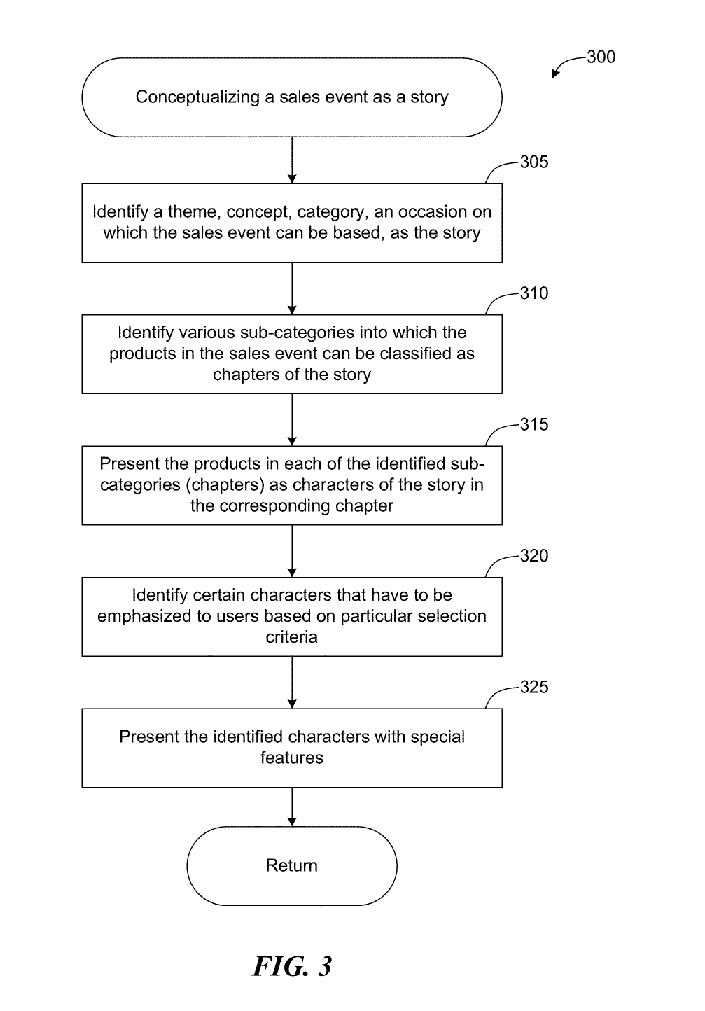

At step 210, the e-commerce entity 105 conceptualizes the sales event as a story. In at least some embodiments, conceptualizing the sales event as a story includes presenting the products in the form of a story. The story can be based on a category, a theme, an occasion, an event, etc. The products are represented as characters and are categorized into a number of chapters of the story. Additional details with respect to conceptualizing the story are described with reference to FIG. 3. At step 215, the e-commerce entity 105 publishes the story online. In at least some embodiments, the story may be published via the website associated with the e-commerce entity 105 or an app of the e-commerce entity 105. Clients 110 may access the story, view and/or purchase the characters presented in the story using the GUI 115. The GUI 115 may be accessed via the website or the app.

FIG. 3 is a flow diagram illustrating a process of conceptualizing an online sales event as a story, according to an embodiment of the disclosed technique. The method 300 may be executed in an environment such as environment 100 of FIG. 1. At step 305, after the sales event is received, the e-commerce entity 105 identifies a theme, an occasion, a category, an event, etc. to which the set of products of the sales event belongs to identify the story. For example, if the sales event is for an event such as Father's day, then the e-commerce entity 105 can create a story for Father's day. In another example, if the sales event is for products related to camping in summer, then the e-commerce entity 105 can create a story for camping. In another example, if the sales event is for a category products such as home improvement, then the e-commerce entity 105 can create a story for home improvement.

At step 310, the e-commerce entity 105 identifies various sub-categories into which the set of products of the sales event can be further classified or categorized. In at least some embodiments, the sub-categories are identified as chapters of the story. For example, if the story is Father's day, then the products that can be gifted to a father can be from product categories such as golf kits, fishing kits, board games, car accessories, electronics, apparel, footwear, etc. Each of these sub-categories can be identified as a chapter of the story.

At step 315, the e-commerce entity 105 identifies various products belonging to each of the identified sub-categories (or chapters) and presents them as characters in the specific chapter. Continuing with the above mentioned example of Father's day story, if “Golf Kits” is identified as one of the chapters, then all products that are related to “Golf Kits,” for example, golf balls, gloves, clubs, etc. may be presented as characters in the chapter “Golf Kits.” Similarly, the products belonging to all other sub-categories are identified and presented as characters in the respective chapters. In certain embodiments, a product can be categorized into more than one chapter, in which case the product is featured as a character in each of the chapters it is categorized into. For example, products such as golf shoes can be categorized into both “Golf Kits” and “Footwear” sub-categories.

As is in a typical story, some characters may be more significant than others, some characters may need more backstory than others, some characters may need more description than others. At step 320, the e-commerce entity 105 identifies these certain characters (also referred to as “special characters’) that have to be emphasized or presented to the users in a distinguishing way over the other characters. The e-commerce entity 105 identifies these special characters based on a particular selection criteria. In at least some embodiments, the selection criteria can include (i) a preference of a particular user for certain characters, (ii) an incentive, from a merchant of a particular character, to the e-commerce entity 105 to sell the particular character, (iii) a surplus availability of the particular character at the merchant or the e-commerce entity, (iv) a demand for the particular character during a particular time of the week, month, or year, or in general, (v) a new introductory character that is offered for sale for a first time, or (vi) a relationship of the particular character to a particular time of a week, a month, or year, etc.

At step 325, the identified characters are presented to the end user with special features. In at least some embodiments, presenting a special character using special features includes presenting the special character in a different size compared to the other characters, providing a narrative in association with the special character, providing an on-character message, for example, on the image of the special character, presenting the special character in a different background color than the other characters, etc.

After the sale of products is conceptualized as a story, the story is published online for the users to view and purchase the products, as described with reference to at least step 215 of FIG. 2.

In at least some embodiments, the method of presenting the sale of products in the form of a story, chapters and characters provides a new paradigm of selling products. Presenting the sale of products in the form of telling a story and presenting the story in a unique GUI provides a pleasant online shopping experience to the user.

FIG. 4 is a flow diagram illustrating a process of generating a GUI for the story of FIG. 3, according to an embodiment of the disclosed technique. The method 400 may be executed in an environment such as environment 100 of FIG. 1. At step 405, the e-commerce entity 105 creates a story for a sales event of a number of products. The products are organized into various chapters of the story based on, for example, the sub-categories a subset of the products belong to. In some embodiments, the e-commerce entity can have a number of sale events, for example, a sale event for a “Father's day” and another sale event for “Weekend Getaways,” and therefore, can create a separate story for each of the sale events. The set of products offered for sale are classified into respective stories, and further into respective chapters of each of the stories.

At step 410, the e-commerce entity 105 generates the story in a GUI. In at least some embodiments, the GUI includes (i) information related to the story, (ii) a table of contents identifying the chapters of the story, and (iii) each of the chapters having corresponding set of related products featured as the characters. The GUI presents the above three entities to the user in a unique way. Additional details with respect to the GUI is described with reference to FIG. 5.

At step 415, the e-commerce entity 105 serves the GUI to a user, in response to a request from the user. In at least some embodiments, the GUI is rendered as a webpage on a computing device. In other embodiments, the GUI can be rendered via an app of the e-commerce entity 105 on the computing device. The computing device can include a computer, a laptop, a mobile phone, a tablet PC, etc.

FIG. 5, which includes FIGS. 5A, 5B and 5C, illustrates an example GUI 500 created using the process of FIG. 4, according to an embodiment of the disclosed technique. The GUI 500 presents the story in at least three separate portions, a first portion 505 having story introduction 520, a second portion 510 having a table of contents 525 and a third portion 515 having the chapters, such as chapter “Golf” 530, “Fishing” 532, etc. and characters (such as character 555 of FIG. 5B) within each of the chapters. The GUI 500 also includes a scroll bar 540 that allows the user to scroll the GUI 500, for example, to view various chapters.

The story introduction 520 represents a particular sale event and can include information such as a name of the story, a set of words associated with the story, an image, a video, an audio, or any combination thereof that describes the story. For example, the name of the story can be “Father's Day,” the set of words describing the story can be “Make your father proud of you,” etc. In at least some embodiments, the story introduction 520 can also include details such as the duration for which the story (or the sales event) is available to the users. The story introduction 520 can also be presented with various background images, colors etc. to make the GUI 500 more attractive.

The table of contents 525 identifies various chapters of the story. The chapters are identified by their corresponding names. In the example of GUI 500, the table of contents 525 includes the chapters “Golf,” “Fishing,” “Board,” “Electronics” and “Apparel.” In other embodiments, the table of contents 525 can also include images (or a combination of various multimedia content) that identify the chapters. Further, each of the chapters in the table of contents 525 is configured to navigate to a particular chapter in the third portion 515, for example, when the user selects a chapter from the table of contents 525. For example, when a user selects “Electronics” chapter from the table of contents 525, the GUI 500 presents the “Electronics” chapter to the user. In order to facilitate navigation to a particular chapter based on the user selection of the chapter, each of the chapters in the table of contents 525 can be generated as a hyperlink, a button, etc. that navigates to a particular chapter upon user selection.

Further, in the table of contents 525, the particular chapter the user is currently viewing can be highlighted. For example, the name of the chapter the user is viewing or clicked on can be presented in a different color, bold text, etc. or in any other way that distinguishes the chapter the user is viewing from other chapters in the table of contents 525. In an embodiment, this would help the user identify the particular chapter of the story the user is viewing in the third portion 515.

In the example of GUI 500, the table of contents 525 is generated as a horizontal header strip. Further, the table of contents 525 is presented immediately below the story introduction 520. When the user scrolls the GUI 500 down, for example, to view the chapters that are not in the viewable area, the contents of the GUI 500, including story introduction 520 and table of contents 525, move up and therefore, the table of contents 525 may move out of the viewable area. In an embodiment, the viewable area is the area of a window that displays the GUI 500 to the user. If the user does not have access to the table of contents 525, it may be inconvenient to the user since the user may have to scroll all the way up until the table of contents 525 is visible again to access the table of contents 525 to select an another chapter. Accordingly, in at least some embodiments, the table of contents 525 is configured to be persistent at a particular position relative to the GUI 500 against scrolling of the GUI 500.

For example, the table of contents 525 can be configured to be persistent at the top most part 542 of the GUI 500, as shown in FIG. 5B. For example, when the user scrolls the GUI 500 up, using the scroll bar 540, to view chapter “Fishing” 532, the table of contents 525 initially scrolls up with the GUI 500, and once the table of contents 525 reaches the top 542 of the GUI 500, it will be persistent at the top 542 position to further scrolling. The chapters in the third portion 515 scroll through the table of contents 525. This way the user can access the table of contents 525 regardless of which particular portion or chapter the user is currently at.

In another example, the table of contents 525 can be configured to be persistent at a position such as below the first portion 505, as shown in FIG. 5A. In such a case, the story introduction 520 and the table of contents 525 remain persistent at their current position even when the GUI 500 is scrolled up/down.

In other embodiments, the table of contents 525 can be configured to be persistently accessible by the user in various other ways. For example, the table of contents 525 can be configured to appear as a pop-up window when the table of contents 525 on the GUI 500 scrolls out of the viewable area. Further, the pop-up window can be configured to be moved, by the user, to any position of the screen of the user device. The look-and-feel of the pop-up window can be made consistent with look-and feel of the table of contents 525 in the GUI 500. Having the table of contents 525 always accessible, regardless of which portion of part of GUI 500 the user is currently at, enables the user to navigate to any chapter from any chapter at any point of time without having to scroll to the initial position to access the table of contents 525.

The chapters such as Golf 530 are displayed in the third portion 515 below the table of contents 525. The user may view the chapters that are not in the viewable area (for example, below bottom 544 of the GUI 500) by scrolling the GUI 500 using the scroll bar 540. For example, in the GUI 500, the chapter “Apparel” is not visible in the third portion 515. The user may view this chapter by either scrolling the GUI 500 using the scroll bar 540 or selecting the chapter “Apparel” from the table of contents 525.

The chapters can be presented in the third potion 515 in various orders. In at least some embodiments, the order of the chapters may be determined on various criteria. For example, a user preference is one such criterion. The chapters that a user has indicated as “interesting” may be presented higher in order than chapters that user has not indicated or indicated as “not-interesting.” Further, in some embodiments, the chapters that the user has indicated as “not-interesting” may not be included in the story. In another example, chapters may be sorted based on alphabetical order. It should be noted that the sorting criteria of chapters is not limited to the above examples.

In at least some embodiments, the order of the chapters can be configured by the user. For example, the user may change the order of the chapters by moving the chapter “Electronics” to the first position and “Golf” to the third position, etc. In some embodiments, the e-commerce entity 105 may provide a settings option (not shown) in the GUI 500 where the user can configure the order of the chapters. In other embodiments, the user may change the order of the chapters by changing the order of the chapters in the table of contents 525 using a “drag-and-drop” technique. In response to the change in order of the chapters in the table of contents 525, the GUI 500 automatically updates the order of the chapters in the third portion 515.

In yet another embodiment, the GUI includes a filter such as filter 535 that allows the user to sort the chapters and/or characters within the chapters in a particular order. The filter 535 can include a drop-down menu having a number of options for sorting the chapters and characters. For example, the filter 535 can have an option to sort chapters by name, old to latest, etc. or characters by price, old to latest, color, etc. When the user chooses to sort the characters by price, either from lowest price to highest price or vice versa, the characters within each of the chapters are sorted accordingly. In another embodiment, the filter 535 can also include an option to show characters of a particular color. The user can select one or more options in the filter 535.

Characters are presented in each of the chapters in a particular format and a particular size. FIG. 5B illustrates an example of a format of characters presented in chapter Golf 530. In one embodiment, the characters presented in each of the chapters, such as character 555, can be images of the products. Generally, in a story, some characters are more significant than the others and some characters may need more backstory, introduction, etc. than the others. These characters may be referred to as special characters. The special characters are determined based on a predefined selection criteria, which is described at least with reference to FIG. 3.

The e-commerce entity 105 presents these special characters in a different format than the other characters (non-special characters). In the example 530, a non-special character such as character 555 is presented in a format and size as shown in FIG. 5B. A special character 580 is displayed with an on-character message “Vintage,” as shown in FIG. 5B. The on character-message can be a text, an image, or a combination. In an embodiment, the character 580, which is a vintage product, is determined as a special character since a user has indicated an interest in vintage products. Accordingly, the e-commerce entity 105 presents the special character 580 in a different format. The on-character message can be objective or subjective. An objective on-character message can include a message such as “Vintage” as shown in FIG. 5B. A subjective on-character message can include a message such as “This is a life changing product.”

In another example, a special character such as character 575 can be presented in a larger size. The larger size can be a pre-defined size, for example, size of two non-special characters or four non-special characters, etc.

In another embodiment, special character 565 is presented with a narrative 570. The narrative 570 can include details such as information regarding the product or merchant, a special characteristic of the product, etc. For example, if the character is a furniture product such as a coffee table, the narrative 570 could include information regarding a type of wood used to make the coffee table, whether it is handmade, a particular country it is made in, a name of the designer of the coffee table, etc.

In yet another embodiment, two related characters, such as a laptop and laptop carry bag, may be grouped and presented as a special character such as group 560.

It should be noted that the above embodiments of presenting the special characters are just examples. The GUI 500 may present special characters in various other ways, including in specific colors, backgrounds, borders, a combination of the above, or in any other way so as to distinguish the special characters from non-special characters.

In at least some embodiments, the GUI 500 presents the story in three separate portions. However, in other embodiments, the GUI 500 may present the story in a different number of portions. Further, the GUI 500 presents each of the portions one below the other. However, in other embodiments, the portions may be presented in a different format. For example, the table of contents 525 can be presented as a vertical header strip or a circular strip rather than a horizontal header strip. The vertical header strip can extend from top 542 of the GUI 500 to the bottom 544 of the GUI 500, and the first portion 505 and the third portion 515 can be presented next to the vertical header strip and with the third portion 515 positioned below the first portion 505.

FIG. 5C shows another example of the GUI created using the process of the FIG. 4. In an embodiment, the GUI 590 can be similar to the GUI 500 of FIGS. 5A and 5B. The GUI 590 includes a story introduction 591, which, in an embodiment, is similar to story introduction 520, and a table of contents 592, which, in an embodiment, is similar to table of contents 525. The products offered for sale in the sales event of GUI 590 includes couches. In this example, the story is given the name “SEAT YOURSELF” as shown in story introduction 591. The table of contents 592 includes chapters such as “Slipcovers” 593, “Leather” and “Tailored & Neutral” into which various couches are categorized. The chapters include characters such as character 594 of chapter 593. Each of the various couches is presented as a character in one or more chapters. The GUI 590 also includes special characters such as special character 595, which is larger in size than non-special characters such as character 594. The special character 595 also includes a narrative 596.

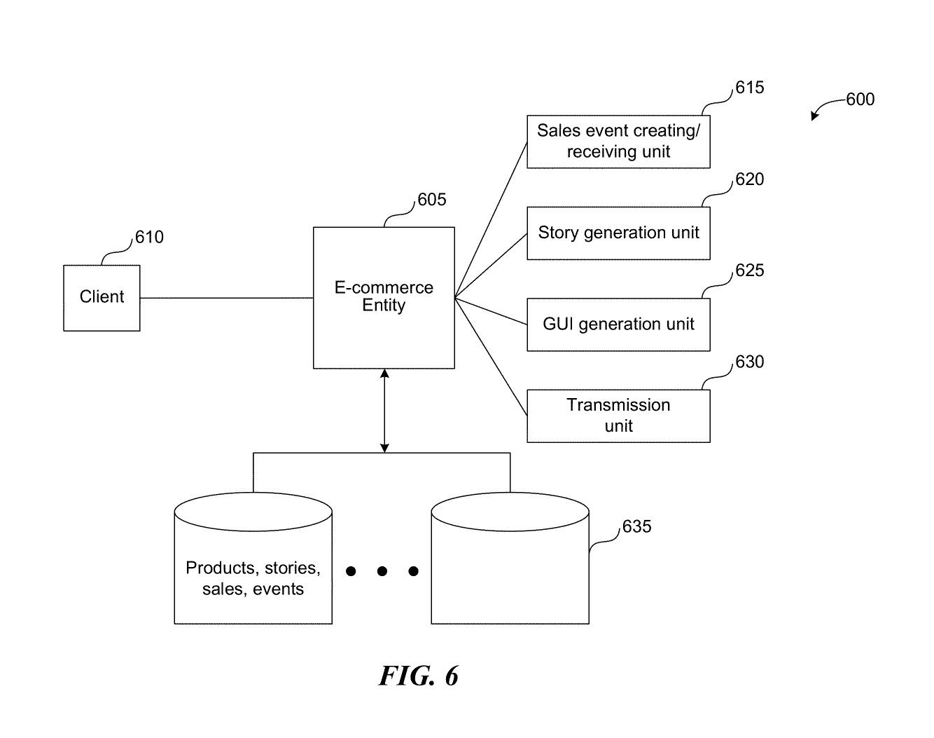

FIG. 6 is a block diagram of a system for generating the GUI for presenting the sales event as a story, according to an embodiment of the disclosed technique. The system 600 includes an e-commerce entity 605 that offers a number of products for sale to consumers such as client 610. In an embodiment, the e-commerce entity 605 is similar to e-commerce entity 105 of FIG. 1. The e-commerce entity 605 includes a sales event creating/receiving unit 615 that creates or receives a sales event of a number of products; a story generation unit 620 that creates a story for the sales event; a GUI generation unit 625 that generates a GUI to present the story; and a transmission unit 630 that transmits the generated GUI to the client 610.

The sales event creating/receiving unit 615 creates or receives a sales event of a number of products. In an embodiment, the sales event creating/receiving unit 615 receives a sales event from a particular vendor or merchant that offers for sale products from that particular merchant. In another embodiment, the e-commerce entity 605 may create its own sales event which offers products including products from a particular merchant, various merchants, manufactured by or for the e-commerce entity 605, or a combination of all. The sales event creating/receiving unit 615 also ensures that the sales events are offered to the clients 610 as per predetermined sales strategies of the e-commerce entity 605 and/or vendors. For example, if a particular sales event is offered only for a predefined period, the sales event creating/receiving unit 615 ensures that the sales event is not made available to the user after the expiry of the predefined period.

The story generation unit 620 generates a story for the sales event. The story generation unit 620 obtains the necessary information for creating the story from the storage system 635. In an embodiment, the storage system 635 is similar to the storage system 125 of FIG. 1. The GUI generation unit 625 includes any necessary applications to generate the GUI for presenting the story. In an embodiment, the GUI generation unit 625 can include applications such as Java, C#, .NET framework, HyperText markup language (HTML), Java Server Pages (JSP), Personal Home Page (PHP). The transmission unit 630 transmits the GUI to the client 610 and the client 610 renders the GUI on its display.

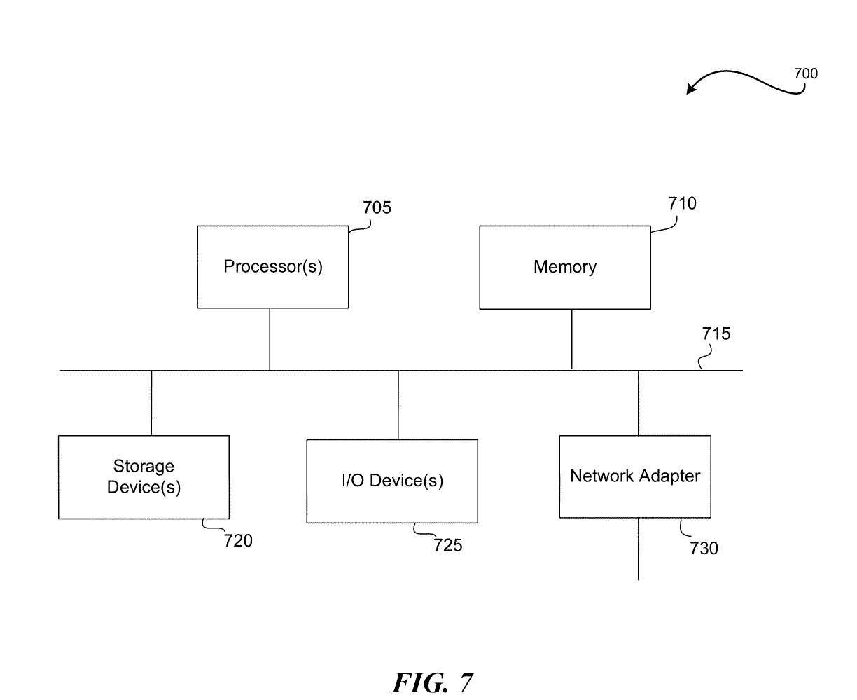

FIG. 7 is a block diagram of an apparatus that may perform various operations, and store various information generated and/or used by such operations, according to an embodiment of the disclosed technique. The apparatus can represent any computer or processing system described herein. The processing system 700 is a hardware device on which any of the entities, components or services depicted in the examples of FIGS. 1-6 (and any other components described in this specification), such as clients 110 or 610, e-commerce entity 105 or 605, sales event creating/receiving unit 615, story generation unit 620, GUI generation unit 625, etc. can be implemented. The processing system 700 includes one or more processors 705 and memory 710 coupled to an interconnect 715. The interconnect 715 is shown in FIG. 7 as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 705 is/are the central processing unit (CPU) of the processing system 700 and, thus, control the overall operation of the processing system 700. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 710 is or includes the main memory of the processing system 700. The memory 710 represents any form of random access memory (RAM), read-only memory (ROM), flash memory, or the like, or a combination of such devices. In use, the memory 710 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 705 through the interconnect 715 are a network adapter 730, a storage device(s) 720 and I/O device(s) 725. The network adapter 730 provides the processing system 700 with the ability to communicate with remote devices, over a network and may be, for example, an Ethernet adapter or Fibre Channel adapter. The network adapter 730 may also provide the processing system 700 with the ability to communicate with other computers within the cluster. In some embodiments, the processing system 700 may use more than one network adapter to deal with the communications within and outside of the cluster separately.

The I/O device(s) 725 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 710 can be implemented as software and/or firmware to program the processor(s) 705 to carry out actions described above. In certain embodiments, such software or firmware may be initially provided to the processing system 700 by downloading it from a remote system through the processing system 700 (e.g., via network adapter 730).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 720 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

1. A method comprising:
creating, by a computer in a computing system, a sales event of a plurality of products as a story, the story including a plurality of chapters, each of the chapters representing a particular relationship between the products and including a set of related products from the products, and each of the products represented as a character of the story in at least one of the chapters;
generating, by the computer, the sales event in a graphical user interface (GUI) in the form of the story, the GUI including at least (i) a story introduction, (ii) a table of contents identifying the chapters of the story, and (iii) each of the chapters having corresponding set of related products as the characters, the generating the sales event in the GUI including:
generating the story introduction in a first portion of the GUI, and
generating the table of contents in a second portion of the GUI as a header strip, the second portion being distinct from the first portion, the header strip including all of the chapters of the story, the header strip positioned below the first portion; and
transmitting, by the computer and in response to a request from a client device in the computing system, the GUI containing the story to the client device for display at the client device.

2. The method of claim 1 further comprising:
rendering, at the client device, the GUI for display to an user.

3. The method of claim 1, wherein generating the sales event in the GUI further includes:
generating a plurality of sections in a third portion of the GUI, each of the sections corresponding to one of the chapters displayed in the header strip, each of the sections displaying the set of related products of the corresponding chapter as a set of characters, the header strip configured to be persistent at a specified position even in response to scrolling of the GUI.

4. The method of claim 3, wherein generating the story introduction includes generating at least one of (i) a text or (ii) an image representative of the story.

5. The method of claim 3, wherein generating the header strip includes generating each of the chapters using at least one of (i) a text or (ii) an image representative of the corresponding chapter.

6. The method of claim 3, wherein generating each of the sections includes generating the set of related products as the set of characters using at least one of (i) a text or (ii) an image representative of the corresponding product.

7. The method of claim 6, wherein generating the set of characters includes:
determining a subset of the set of characters based on a selection criterion, and
generating the subset of the set of characters with special features.

8. The method of claim 7, wherein the selection criterion includes at least one of (i) a preference of a particular user for certain characters, (ii) an incentive, from a merchant of a particular character to an e-commerce entity selling the characters, to sell the particular character, (iii) a surplus supply of the particular character at the merchant, (iv) a demand for the particular character during a particular time of the year, (v) a new introductory character that is offered for sale for a first time, or (vi) a relationship of the particular character to a particular time of a week, a month, or year.

9. The method of claim 7, wherein generating the subset of the set of characters with the special features includes generating the subset of the set of characters (i) in a different size relative to other characters in the set, (ii) using specific narratives in association with images of the subset of characters, (iii) using on-character message, or (iv) by emphasizing the subset over the other characters in the set.

10. The method of claim 3, wherein each of the first portion, second portion, and third portion is organized in the GUI in the order of the first portion, second portion, and third portion.

11. The method of claim 3, wherein an order of the chapters displayed in the third portion of the GUI is configurable by an user of the client device.

12. The method of claim 3, wherein the GUI includes a filter that allows a user to (a) sort the chapters displayed in the third portion based on a pre-defined sort criterion, (b) sort the set of characters displayed in each of the chapters based on the pre-defined sort criterion, (c) group the set of characters in each of the chapters based on the pre-defined sort criterion, or (d) select a number of characters from the set of characters to be displayed in the GUI.

13. The method of claim 12, wherein the pre-defined sort criterion includes at least one of (i) a price of the set of characters, (ii) name of each of the set of characters, (iii) characteristics of the set of characters, or (iv) name of the chapters.

14. The method of claim 1, wherein the sales event is an online sale event, wherein the sales event is one of a plurality of sales events and each of the sales events are offered to an end-user for a predefined period of time.

15. The method of claim 1, wherein the sales event or the story is based on at least one of (i) a concept, (ii) a theme, (iii) an occasion, or (iv) an event.

16. A computer-readable storage medium storing computer-executable instructions for generating a graphical user interface (GUI) on a computing device, comprising:
instructions for generating a first portion of the GUI, the first portion including a story introduction, the story representing a sales event of a plurality of products, the story including a plurality of chapters, each of the chapters representing a particular relationship between the products and including a set of related products from the products, and each of the products represented as a character of the story in at least one of the chapters;
instructions for generating a second portion of the GUI, the second portion including a table of contents of the story, the table of contents rendered as a horizontal header strip, the header strip displaying the plurality of chapters discretely, the header strip positioned below the first portion, the header strip configured to be persistent at a predefined position even in response to scrolling the GUI, the second portion being distinct from the first portion; and
instructions for generating a third portion of the GUI, the third portion including a plurality of sections, each of the sections corresponding to one of the chapters displayed in the header strip, each of the sections displaying the set of related products of the corresponding chapter as a set of characters.

17. The computer-readable storage medium of claim 16, wherein the story introduction includes at least one of a text or an image representative of the story, wherein the header strip identifies each of the chapters using at least one of a text or an image representative of the corresponding chapter, and wherein each of the set of characters in each of the chapters are displayed using at least one of a text or an image representative of the corresponding product.

18. The computer-readable storage medium of claim 17, wherein one or more of the chapters generate a subset of the set of characters using special features, the subset of the set of characters determined based on a selection criterion.

19. The computer-readable storage medium of claim 18, wherein the instructions for generating the subset of the set of characters using the special features include instructions for generating the subset of characters (i) in a different size relative to other characters in the set, (ii) using specific narratives in association with images of the subset of characters, (iii) using on-character messages, or (iv) by emphasizing the subset over the other characters in the set.

20. The computer-readable storage medium of claim 16 further comprising:
instructions for generating a filter that allows a user to (a) sort the chapters displayed in the third portion based on a pre-defined sort criterion, (b) sort the set of characters displayed in the corresponding chapter based on a predefined criterion, (c) group the set of characters based on the predefined criterion, or (d) select a number of characters from the set of characters to be displayed in the GUI.

21. An apparatus comprising:
a processor;
a sales event creating unit that works in co-operation with the processor to create a sales event of a plurality of products as a story, the story including a plurality of chapters, each of the chapters representing a particular relationship between the products and including a set of related products from the products, and each of the products represented as a character of the story in at least one of the chapters;
a graphical user interface (GUI) generation unit that works in cooperation with the processor to generate the sales event in the GUI in the form of the story, the GUI including at least (i) a story introduction, (ii) a table of contents identifying the corresponding chapters of the story, and (iii) each of the chapters having corresponding related products as the characters, the GUI generation unit further configured to:
generate the story introduction in a first portion of the GUI, and
generate the table of contents in a second portion of the GUI as a header strip, the second portion being distinct from the first portion, the header strip including all of the chapters of the story, the header strip positioned below the first portion; and
a transmission unit that works in cooperation with the processor to serve, in response to a request from a client device, the GUI containing the story to the client device.

22. A method comprising:
generating, by a computer in a computing system, a sales event of a plurality of products as a story, the story based on one of a theme, an occasion, or a category, wherein the sales event is one of a plurality of sales events, each of the sales events configured to expire after a specified period;
generating a plurality of chapters for the story, each of the chapters representing a particular relationship between the products and including a set of related products from the products, wherein the set of related products includes a subset of the products identified by the computer based on a user profile of a user;
identifying each of the products as a character of the story to generate a plurality of characters, wherein each of the characters is configured to feature in at least one of the chapters, wherein one or more of the products in each of the chapters are identified as special characters;
receiving, by the computer and from a client device of the user, a request for the sales event; and
presenting, by the computer and in response to the request, the sales event in an online graphical user interface (GUI), the online GUI presenting at least:
(i) a story introduction that displays a set of words that is descriptive of the story of the sales event,
(ii) a table of contents that displays information regarding all of the chapters of the story, and
(iii) a set of the products of at least one of the chapters, wherein the set of the products includes a particular product identified based on a user preference specified for a type of the particular product in the user profile, wherein the particular product is identified as a special character, wherein the special character is presented with an on-character message, the on-character message superimposed on the special character, the on-character message being an objective message or a subjective message.

23. A method comprising:
receiving, by a computer in a computing system and from a client device of a user, a request for accessing a sales event, wherein the sales event is one of a plurality of sales events, each of the sales events configured to expire after a specified period, wherein after a current sales event of the sales events expires a next sales event of the sales events is published;
receiving a user selection of a particular sales event of the sales events from the user, the particular sales event publishing of a plurality of products for sale;
generating, by the computer, the particular sales event as a story, the story based on one of a theme, an occasion, or a category;
categorizing the products into a plurality of chapters of the story, each of the chapters representing a particular relationship between the products and including a set of related products from the products, wherein at least some of the products are featured in more than one chapter of the chapters;
identifying each of the products as a character of the story to generate a plurality of characters, wherein one or more of the products in each of the chapters are identified as special characters; and
presenting, by the computer and in response to the request, the sales event in an online graphical user interface (GUI), the online GUI presenting at least:
(iv) a story introduction that displays a set of words that is descriptive of the story of the sales event and a timer that indicates a duration after which the sales event expires,
(v) a table of contents that displays information regarding all of the chapters of the story, and
(vi) a set of the characters of at least one of the chapters, wherein the set of the characters includes a first product, a second product and a third product, the first product identified as a first special character, wherein the first special character is presented with a narrative that describes the first product, wherein a combination of the second product and the third product is identified as a second special character, the second special character presenting the second product and the third as a single group.
